(19) United States
(12) Patent Application Publication
(10) Pub. No.: US 2024/0222905 A1
(43) Pub. Date: Jul. 4, 2024

(54) RETENTION APPARATUS FOR AN ELECTRICAL CONNECTOR AND ELECTRONIC APPARATUS INCORPORATING SAME

(71) Applicant: UBICQUIA, INC., FORT LAUDERDALE, FL (US)

(72) Inventors: Claudio Santiago Ribeiro, Evanston, IL (US); Cesar Eduardo Nunez, Miramar, FL (US)

(21) Appl. No.: 18/401,444

(22) Filed: Dec. 30, 2023

Related U.S. Application Data
(60) Provisional application No. 63/436,485, filed on Dec. 30, 2022.

(51) Int. Cl. H01R 13/625; F21V 23/06

(52) U.S. Cl. CPC H01R 13/625; F21V 23/06

(57) ABSTRACT

A retention apparatus for an electrical connector includes two or more spatially adjustable retention members arranged about a perimeter of the electrical connector and an adjustment member surrounding the retention members. The adjustment member is operable to selectively move the retention members toward the electrical connector when retention of the connector is desired and away from the electrical connector when retention of the connector is not desired (e.g., when the electrical connector is to be released or removed). The retention apparatus may also include a body member that retains the retention members in a predetermined arrangement relative to one another during movement thereof by the adjustment member. The retention apparatus may form part of an electronic apparatus that includes a housing and the electrical connector about which the retention apparatus is arranged, where the electrical connector may be accessible through a surface of the housing.

### CROSS-REFERENCE TO RELATED APPLICATIONS

The present application claims the benefit of and priority upon U.S. Provisional Patent Application No. 63/436,485, which was filed on Dec. 30, 2022, and is incorporated herein by this reference as if fully set forth herein.

### TECHNICAL FIELD

The present disclosure relates generally to maintaining secure electrical connection between electrical connectors of electrical or electronic devices. More particularly, but not exclusively, the present disclosure relates to a retention apparatus for an electrical connector and an electronic apparatus that incorporates such a retention apparatus.

### BACKGROUND

Various types of electronic devices, such as networked lighting controllers, small cell access nodes, wireless access points, and edge processing devices, are mounted in outside or outdoor environments subject to structural or environmental constraints and hazards. In some cases, such electronic devices integrate their power or other connectors into walls or other surfaces of the devices' housings instead of using a cord or other more obtrusive connection mechanism. Providing electrical connections directly through housing surfaces of the electronic devices allows for cleaner, more attractive installations with minimal cables or wires hanging from the installation points. Such installations may provide safety and functional benefits also. For example, in some circumstances, electronic devices are connected to electrical sockets atop streetlight fixtures. To enable such devices to keep a low profile to withstand wind loading and other environmental factors, the devices often integrate their electrical power connectors into the bottom surfaces of their housings. While providing low profile, clean, and generally ergonomic installations, such couplings are still susceptible to high winds, debris, vibrations, and other environment and external factors that may cause the connections between the electrical connectors of the electronic devices and the electrical connectors of the streetlight fixtures to loosen over time, potentially impacting electronic device performance.

All of the subject matter discussed in the Background section of the present disclosure is not necessarily prior art and should not be assumed to be prior art merely as a result of its inclusion in the Background section. For example, any recognition of problems in the prior art discussed in the Background section or associated with such subject matter should not be treated as prior art unless expressly stated to be prior art. Instead, the discussion of any subject matter in the Background section should be treated as part of the inventors' approach to the particular problem, which, in and of itself, may also be inventive.

### SUMMARY

According to one exemplary embodiment, a retention apparatus for an electrical connector includes a plurality (two or more) spatially adjustable retention members arranged about a perimeter of the electrical connector and an adjustment member surrounding the retention members. The adjustment member is operable (e.g., manually or electromechanically) to selectively move the retention members toward the electrical connector when retention of the connector is desired and may be further operable to move the retention members away from the electrical connector when retention of the connector is not desired (e.g., when the electrical connector is to be released or removed from its electrical connection). The retention apparatus may also include a body member that retains the retention members in a predetermined arrangement relative to one another during movement the retention members by the adjustment member. The retention apparatus may form part of an electronic apparatus that includes a housing and the electrical connector about which the retention apparatus is arranged, where the electrical connector may be optionally accessible through or integrated with a surface (e.g., a bottom surface) of the housing.

According to an alternative exemplary embodiment, the retention apparatus' adjustment member may be rotatable and operable to move the retention members toward the electrical connector when the adjustment member is rotated in a first direction (e.g., clockwise or counterclockwise). The adjustment member may be further operable to move the retention members away from the electrical connector when the adjustment member is rotated in a second direction (e.g., counterclockwise or clockwise) that is opposite to the first direction. With respect to this embodiment, the adjustment member may be a threaded nut.

According to an alternative exemplary embodiment, the retention apparatus' adjustment member may be selectively expandable and contractable. For example, the adjustment member may be a ratchet strap or the like.

According to a further exemplary embodiment, the electrical connector may be configured to mate with a mating electrical connector located atop a streetlight fixture, such as a luminaire. In such a case, the retention members may be sized and shaped to permit the retention members, when moved toward the electrical connector by the adjustment member, to engage a collar of the mating electrical connector after the electrical connector has been mated with the mating electrical connector. According to one exemplary implementation of this embodiment, the electrical connector may be a multi-pronged connector (such as, for example, a 3-pin, 5-pin, or 7-pin twist lock male connector compliant with the American National Standards Institute (ANSI) C136 roadway lighting series of standards), and the mating electrical connector may be a corresponding mating socket (such as, for example, a 3-pin, 5-pin, or 7-pin twist lock female receptacle or socket compliant with the ANSI C136 roadway lighting series of standards).

According to a further exemplary embodiment, an electronic apparatus includes a housing, an electrical connector, and a retention apparatus for the electrical connector. According to this embodiment, the retention apparatus includes two or more spatially adjustable retention members arranged about a perimeter of the electrical connector and an adjustment member surrounding the retention members. The adjustment member is operable (e.g., manually or electromechanically) to selectively move the retention members toward the electrical connector when retention of the connector is desired and may be further operable to move the retention members away from the electrical connector when retention of the connector is not desired (e.g., when the electrical connector is to be released or removed from its electrical connection). The retention apparatus may also include a body member that retains the retention members in a predetermined arrangement relative to one another during movement of the retention members by the adjustment member. The retention apparatus may be optionally integrated with the housing of the electronic apparatus. The electrical connector may be optionally accessible through or integrated with a surface (e.g., a bottom surface) of the housing. The electronic apparatus may be or include an ambient light sensor, a light controller, a wireless access point, a wireless gateway, a small cell access node, an Internet of Things (IOT) sensor, an artificial intelligence processor, a utility-grade power meter, a camera, and/or any other desired electronic device.

According to an alternative exemplary embodiment, the adjustment member of the electronic apparatus' retention apparatus may be rotatable and operable to move the retention members toward the electrical connector when the adjustment member is rotated in a first direction (e.g., clockwise or counterclockwise). The adjustment member may be further operable to move the retention members away from the electrical connector when the adjustment member is rotated in a second direction (e.g., counterclockwise or clockwise) that is opposite to the first direction (e.g., when the electrical connector is to be released or removed from its electrical connection). With respect to this embodiment, the adjustment member may be a threaded nut.

According to an alternative exemplary embodiment, the adjustment member of the electronic apparatus' retention apparatus may be selectively expandable and contractable. For example, the adjustment member may be a ratchet strap or the like.

According to a further exemplary embodiment, the electronic apparatus' electrical connector may be configured to mate with a mating electrical connector located atop a streetlight fixture, such as a luminaire. In such a case, the retention members may be sized and shaped to permit the retention members, when moved toward the electrical connector by the adjustment member, to engage a collar of the mating electrical connector after the electrical connector has been mated with the mating electrical connector. According to one exemplary implementation of this embodiment, the electrical connector may be a multi-pronged connector (such as, for example, a 3-pin, 5-pin, or 7-pin twist lock male connector compliant with the ANSI C136 roadway lighting series of standards), and the mating electrical connector may be a corresponding mating socket or receptacle.

According to yet another exemplary embodiment, a streetlight-mountable electronic apparatus includes a housing, an electrical connector interconnectable with a mating electrical connector located atop a luminaire of a streetlight, and a retention apparatus for the electrical connector. According to this embodiment, the retention apparatus includes two or more spatially adjustable retention members and a rotatable adjustment member surrounding the retention members. The retention members are arranged about a perimeter of the electrical connector so as to be outside a diameter of a collar of the mating electrical connector. The adjustment member is operable (e.g., manually or electromechanically) to move the retention members toward the electrical connector to permit engagement with the collar of the mating electrical connector when the adjustment member is rotated in a first direction (e.g., clockwise or counterclockwise). The adjustment member may be further operable to move the retention members away from the electrical connector to permit disengagement with the collar of the mating electrical connector when the adjustment member is rotated in a second direction that is opposite to the first direction (e.g., when the electrical connector is to be released or removed from its electrical connection). The retention apparatus may also include a body member that retains the retention members in a predetermined arrangement relative to one another during movement of the retention members by the adjustment member. The retention apparatus may be optionally integrated with the housing of the streetlight-mountable electronic apparatus. The electrical connector may be optionally accessible through or integrated with a surface (e.g., a bottom surface) of the streetlight-mountable electronic apparatus' housing. The electronic apparatus may be or include an ambient light sensor, a light controller, a wireless access point, a wireless gateway, a small cell access node, an IoT sensor, an artificial intelligence processor, a utility-grade power meter, a camera, and/or any other desired electronic device.

According to another exemplary embodiment, the electrical connector of the streetlight-mountable electronic apparatus may be a multi-pronged connector (such as, for example, a 3-pin, 5-pin, or 7-pin twist lock connector compliant with the ANSI C136 roadway lighting series of standards), and the mating electrical connector atop the streetlight luminaire may be a corresponding mating socket or receptacle.

In some alternative embodiments, an outdoor-mountable electronic apparatus with a housing configured for secure electrical connector mounting to a fixture may include a connector assembly having a plurality of protruding conductors arranged and configured in a substantially circular pattern, and a twistable or rotatable support sleeve around a support housing. Once the connector assembly is coupled to a mated structure of the fixture, the support sleeve, which is in a threaded relationship with the support housing, may collapse the support housing as the support sleeve twists or turns around the support housing to compress the support housing against the mated structure to provide a secure connection between the electronic apparatus and the fixture.

In some other alternative embodiments, the connector assembly may be a National Electrical Manufacturers Association (NEMA) connector that complies with the ANSI C136 roadway lighting series of standards. In some embodiments, the fixture may be a streetlight. In some embodiments, the connector assembly may be a NEMA connector, and the fixture may be a streetlight having a luminaire NEMA connector for mating with the NEMA connector of the outdoor-mountable electronic apparatus.

In some other embodiments, the mating structure of the fixture may be a collar of a luminaire NEMA connector, and the support sleeve may twist or turn around the support housing to compress the support housing against the collar of the luminaire NEMA connector to provide a secure connection between the electronic apparatus and the fixture. In some such embodiments, the twistable or rotatable support sleeve around the support housing may operate in a manner similar to the operation of a chuck of a drill.

In some embodiments, the outdoor-mountable electronic apparatus may be one of a streetlight-mountable sensor, a streetlight-mountable wireless access point, or a streetlight-mountable small cell access node or device.

In some other alternative embodiments, a streetlight-mountable electronic apparatus configured for secure electrical connector mounting to a streetlight luminaire may include a NEMA connector assembly configured to mate with a NEMA connector of the streetlight luminaire, and a twistable or rotatable support sleeve configured around a support housing. In such an embodiment, once the NEMA connector assembly is coupled to the luminaire NEMA connector, the support sleeve may collapse the support housing as the support sleeve twists or turns around the support housing to compress the support housing against the luminaire's NEMA connector to provide a secure connection between the streetlight-mountable electronic apparatus and the streetlight luminaire. In some alternative embodiments, the support sleeve may be in a threaded relationship with the support housing.

In some other embodiments, the support sleeve may twist or turn around the support housing to compress the support housing against a collar of the luminaire's NEMA connector to provide a secure connection between the electronic apparatus and the streetlight luminaire. In some such embodiments, the twistable or rotatable support sleeve may operate in a manner similar to the operation of a chuck of a drill.

In some other alternative embodiments, an outdoor-mountable electronic apparatus connector assembly configured for secure mounting to a fixture may include a plurality of protruding conductors arranged in a substantially circular pattern and a twistable or rotatable support sleeve around a support housing configured and constructed in a threaded relationship with the support housing to collapse the support housing as the support sleeve twists or turns around the support housing to compress the support housing against a mating structure of the fixture to provide a secure connection between the electronic apparatus connector and the fixture. In some such embodiments, the outdoor-mountable electronic apparatus connector assembly forms a part of one of a streetlight-mountable sensor, a streetlight-mountable wireless access point, or a streetlight-mountable small cell access node or device. In some other embodiments, the connector assembly may include a NEMA connector, and the fixture may be a streetlight having a luminaire NEMA connector for mating with the NEMA connector. In some further embodiments, the twistable or rotatable support sleeve may operate in a manner similar to the operation of a chuck of a drill.

In some further embodiments, the mating structure of the fixture may be a collar of a luminaire NEMA connector, and the support sleeve may twist or turn around the support housing to compress the support housing against the collar of the luminaire NEMA connector to provide a secure connection between the electronic apparatus connector assembly and the fixture. In some such embodiments, the support sleeve may be in a threaded relationship with the support housing.

### BRIEF DESCRIPTION OF THE DRAWINGS

Non-limiting and non-exhaustive embodiments of the present disclosure are described with reference to the accompanying drawings, wherein like reference numerals refer to like components or elements throughout the various views unless otherwise specified. The sizes and relative positions of elements in the drawings are not necessarily drawn to scale. For example, the shapes of various elements are selected, enlarged, and positioned to improve drawing legibility and further an understanding of the present disclosure. The particular shapes of the elements as drawn have been selected for case of recognition in the drawings.

FIG. 1 illustrates a bottom plan view of a retention apparatus for an electrical connector, in accordance with exemplary embodiments of the present disclosure.

FIG. 2 illustrates a chuck of a drill as having a structure that can be adapted to implement a retention apparatus for an electrical connector, in accordance with exemplary embodiments of the present disclosure.

FIG. 3 illustrates a bottom perspective view of an exemplary streetlight-mountable electronic apparatus that includes a retention apparatus for an electrical connector of the electronic apparatus, in accordance with one exemplary embodiment of the present disclosure.

FIG. 4 illustrates a bottom, perspective, close-up view of the exemplary streetlight-mountable electronic apparatus of FIG. 3.

FIG. 5 illustrates an exploded view of an electrical connector portion of a streetlight-mountable electronic apparatus as positioned over a mating connector atop a streetlight luminaire, in accordance with further exemplary embodiments of the present disclosure.

FIG. 6 illustrates an exploded view of an electrical connector portion of an alternative streetlight-mountable electronic apparatus as positioned over a mating connector atop a streetlight luminaire, in accordance with further exemplary embodiments of the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. Also in these instances, well-known structures may be omitted or shown and described in reduced detail to avoid unnecessarily obscuring descriptions of the embodiments.

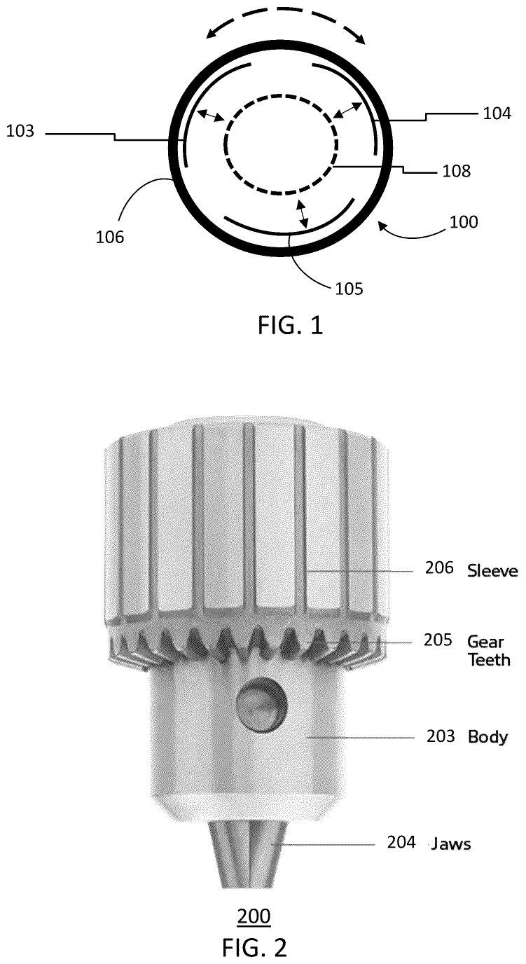

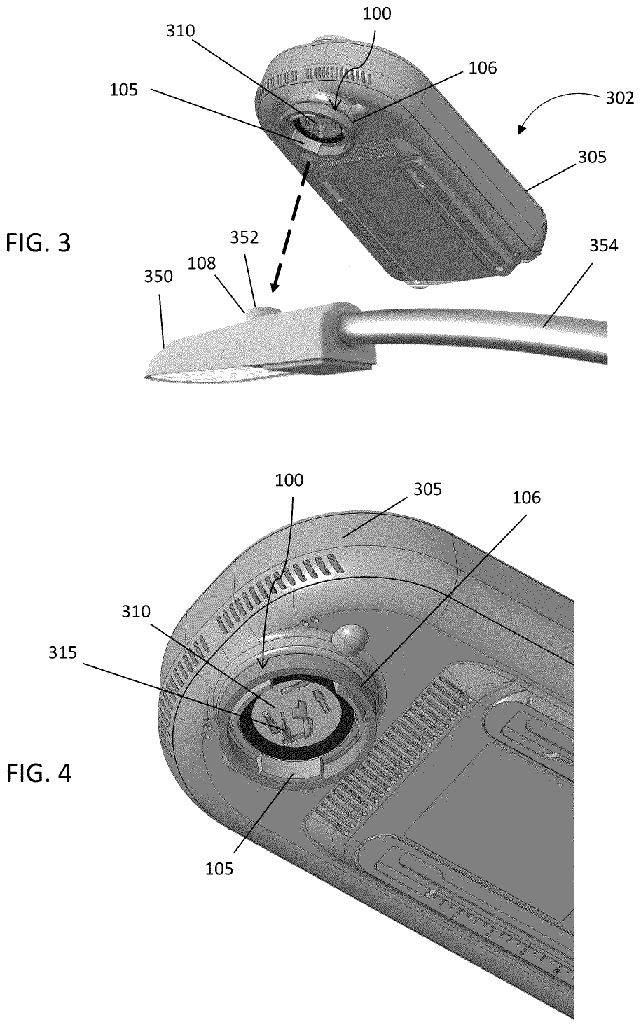

Referring to FIG. 1, an exemplary adjustable retention apparatus 100 for a connector (e.g., a plug or a socket) is shown in bottom plan view as positioned above a collar 108 or other boundary of a mating connector (e.g., a socket or a plug). The retention apparatus 100 includes two or more spatially adjustable retention members 103-105 (three shown for illustrative purposes only) arranged about a perimeter of the electrical connector (not shown in FIG. 1 but see exemplary electrical connector 310 in FIG. 3) and an adjustment member 106 surrounding the retention members 103-105. As indicated by the bidirectional arrows shown between the retention members 103-105 and the collar 108 of the mating connector (not shown in FIG. 1 but see exemplary mating connector 352 in FIG. 3), the adjustment member 106 is operable to selectively move the retention members 103-105 toward the electrical connector (and toward the collar 108 of the mating connector) when retention of the electrical connector is desired and away from the electrical connector when retention of the electrical connector is not desired (e.g., when the electrical connector is to be released or removed from the mating connector).

The retention apparatus 100 may form part of an electronic apparatus that includes a housing and the electrical connector about which perimeter the retention apparatus 100 is arranged, where the electrical connector may be optionally accessible through or integrated with a surface of the housing. Exemplary electronic apparatus 302, 501, 601 that include a retention apparatus 100 are discussed below with respect to FIGS. 3-6.

According to one exemplary embodiment, the retention member's adjustment member 106 is rotatable, as generally indicated by the curved bidirectional arrow at the top of FIG. 1, and operable to move the retention members 103-105 toward the electrical connector when the adjustment member 106 is rotated in a first direction (e.g., either clockwise or counterclockwise depending on the implementation of the adjustment member 106). The adjustment member 106 may be further operable to move the retention members 103-105 away from the electrical connector when the adjustment member 106 is rotated in a second direction (e.g., either counterclockwise or clockwise depending on the implementation of the adjustment member 106) that is opposite to the first direction. With respect to this embodiment, the adjustment member 106 may be a threaded nut.

According to an alternative exemplary embodiment, the retention member's adjustment member 106 may be selectively expandable and contractable. For example, the adjustment member 106 may be a ratchet strap, tie wrap, or the like.

According to another alternative exemplary embodiment, the retention apparatus 100 may further include a body member, which may be similar in function to a body 203 of a drill chuck 200 as illustrated in exemplary form in FIG. 2. In such a case, the body member of the retention apparatus 100, when included, may retain the retention members 103-105 in a predetermined arrangement relative to one another (e.g., at relative adjacent angles) during movement of the retention members 103-105 by the adjustment member 106. In this embodiment, the retention members 103-105 may function similar to the jaws 204 of the exemplary drill chuck 200 and the adjustment member 106 may function similar to the sleeve 206 of the exemplary drill chuck 200. However, unlike with the exemplary drill chuck 200, the retention members 103-105 of the retention apparatus 100 may not necessarily extend beyond the edge or end of the adjustment member 106 or the body member (when included) as do the jaws 204 of the drill chuck 200 when the jaws 204 are adjusted to retain a very thin drill bit.

Referring now to FIGS. 3 and 4, an exemplary streetlight-mountable electronic apparatus 302 is shown, which includes a retention apparatus 100 for an electrical connector 310 of the electronic apparatus 302. More particularly, the exemplary electronic apparatus 302 includes, inter alia, a housing 305, the electrical connector 310, and the retention apparatus 100. According to this embodiment, the retention apparatus 100 includes two or more spatially adjustable retention members 103-105 (only retention member 105 is identified for clarity purposes) arranged about a perimeter of the electrical connector 310 and an adjustment member 106 surrounding the retention members 103-105. In this exemplary embodiment, the retention apparatus 100 is optionally integrated with the housing 305 of the electronic apparatus 302. Additionally, the electrical connector 310 may be accessible through or integrated with a surface of the housing 305 (e.g., a bottom surface of the housing 305). The exemplary electronic apparatus 302 may be or include an ambient light sensor, a light controller, a wireless access point, a wireless gateway, a small cell access node, an IoT sensor, an artificial intelligence processor, a utility-grade power meter, a camera, and/or any other desired electronic device.

In the exemplary embodiment illustrated in FIGS. 3 and 4, the exemplary electrical connector 310 is configured to mate with a mating electrical connector 352 located atop a streetlight luminaire 350. The streetlight luminaire 350 may be supported by an arm 354 of a utility or streetlight pole (not shown). In this particular case, the retention members 103-105 may be sized and shaped to permit the retention members 103-105, when moved toward the electrical connector 310 by the adjustment member 106, to engage a collar 108 of the mating electrical connector 352. According to one exemplary implementation of this embodiment, the electrical connector 310 may include multiple pins or prongs 315 (e.g., may be a multi-pronged connector), and the mating electrical connector 352 may be a corresponding or complementary socket. In one such exemplary implementation, the prongs 315 of the electrical connector 310 may twist lock in the socket of the mating electrical connector 352. For example, the electrical connector 310 may be a multi-pronged connector (such as, for example, a 3-pin, 5-pin, or 7-pin twist lock connector compliant with the ANSI C136 roadway lighting series of standards), and the mating electrical connector 352 atop the streetlight luminaire 350 may be a corresponding mating socket or receptacle also compliant with the ANSI C136 roadway lighting series of standards. Additionally or alternatively, the electrical connector 310 may receive electrical power from the mating electrical connector 352. Where the electrical connector 310 is intended to provide or receive light control or other data to or from the streetlight luminaire 350, the electrical connector 310 may also include pins for use in implementing a data communication protocol, such as the Digital Addressable Lighting Interface (DALI) protocol or a replacement protocol.

After the electrical connector 310 of the exemplary electronic apparatus 302 has been interconnected or mated with a mating connector, such as the electrical connector 352 atop the streetlight luminaire 350, the adjustment member 106 is appropriately adjusted (e.g., manually or electromechanically rotated where the adjustment member 106 is rotatable or contracted where the adjustment member is otherwise expandable and contractable) to move the retention members 103-105 toward the electrical connector 310 so as to engage the collar 108 of the mating connector 352. Engagement of the retention members 103-105 to the mating connector's collar 108 helps keep the two connectors 310, 352 engaged (and helps keep the electronic apparatus 302 secured to the device containing the mating connector 352, such as the illustrated luminaire 350) in the event of various stresses that may be placed on the electronic apparatus 302 and/or the device with the mating connector 352, such as wind loading, vibration, and other stresses.

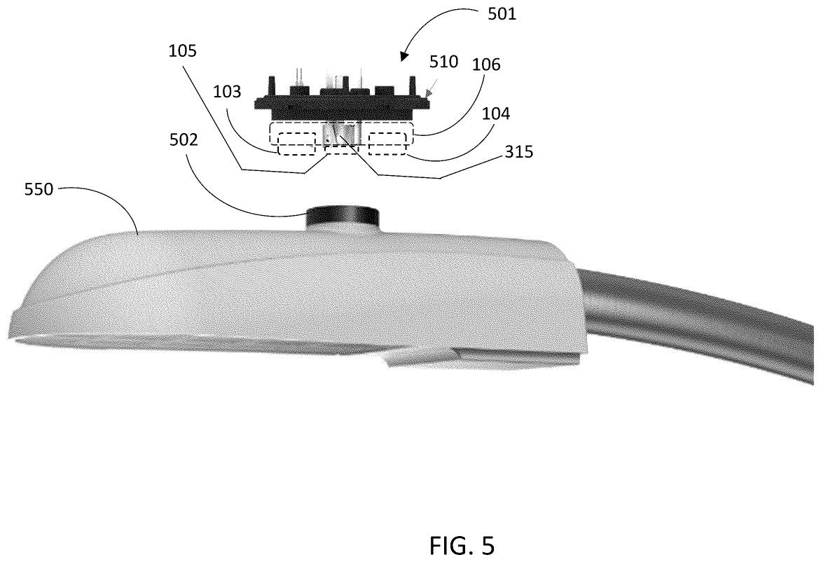

Referring to FIG. 5, a connector 510 of an alternative exemplary electronic apparatus 501 is shown in exploded form positioned above a mating connector of another electronic apparatus 550, such as a streetlight luminaire. As illustrated in this embodiment, the electronic apparatus 501 includes a connector retention apparatus 100, which includes two or more retention members 103-105 (three shown for illustration purposes) surrounded by an adjustment member 106. In FIG. 5, the housing of the exemplary electronic apparatus 501 has been omitted for clarity purposes. The retention members 103-105 are arranged about a perimeter of the connector 510 and are shown as positioned just outside the outer diameter of a collar 502 of the mating connector. After the two connectors are mated together, the adjustment member 106 may be manipulated (e.g., rotated, pulled, squeezed, or so forth) so as to move the retention members 103-105 into engagement with the collar 502 of the mating connector. In this exemplary embodiment, the connector 510 of the electronic apparatus 501 has multiple prongs 315 and the mating connector is a socket. However, the retention apparatus 100 of the present disclosure may be used with other types of connectors, including those that interconnect magnetically, those that are press-fit, or those that interconnect in various other ways. Additionally, while the retention members 103-105 illustrated in FIG. 5 are shown extending beyond the bottom edge of the adjustment member 106, such extension is not necessary and is shown merely to facilitate the description of the embodiment illustrated in FIG. 5.

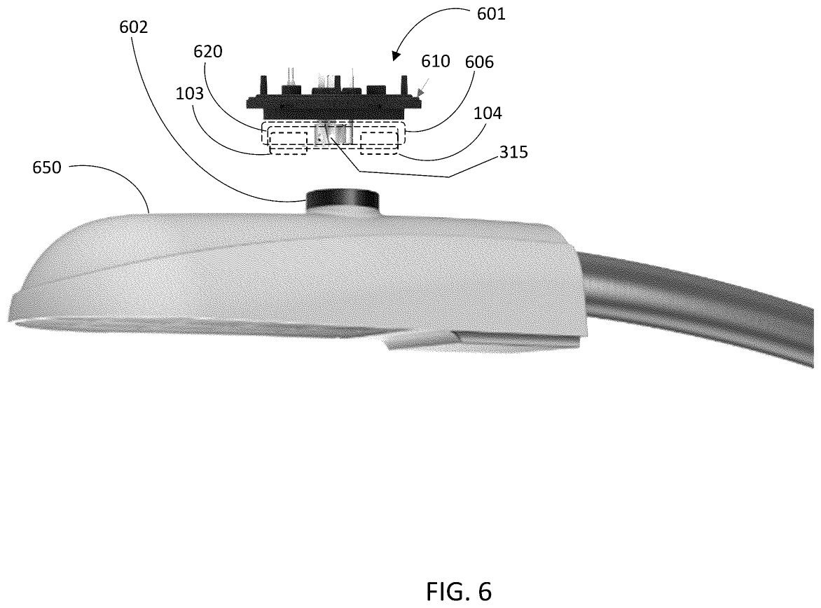

Referring to FIG. 6, a connector 610 of another alternative exemplary electronic apparatus 601 is shown in exploded form positioned above a mating connector of another electronic apparatus 650, such as a streetlight luminaire. As illustrated in this embodiment, the electronic apparatus 601 includes a connector retention apparatus, which includes two or more retention members 103-105 (three shown for illustration purposes) surrounded by a body member 620 and an adjustment member 606 surrounding the body member 620. In FIG. 6, the housing of the exemplary electronic apparatus 601 has been omitted for clarity purposes. The retention members 103-105 are arranged about a perimeter of the connector 610 and are shown as positioned just outside the outer diameter of a collar 602 of the mating connector. After the two connectors are mated together, the adjustment member 606 may be manipulated (e.g., rotated) so as to move the retention members 103-105 into engagement with the collar 502 of the mating connector. In this exemplary embodiment, the body member 620 functions to retain or keep the retention members 103-105 in a predetermined arrangement relative to one another (e.g., at predetermined angles relative to one another) during movement of the retention members 103-105 by the adjustment member 606. Therefore, according to this exemplary embodiment, the retention apparatus is constructed and operates in a manner very similar to the construction and operation of a drill chuck 200.

As was the case in the embodiment described above with respect to FIG. 5, the connector 610 of the exemplary electronic apparatus 601 includes multiple prongs 315 and the mating connector is a socket. However, in contrast to the embodiment described above with respect to FIG. 5, the retention apparatus described with respect to FIG. 6 may be used with other types of connectors, including those that interconnect magnetically, those that are press-fit, or those that interconnect in various other ways. Additionally, while the retention members 103-105 illustrated in FIG. 6 are shown extending beyond the bottom edges of the body member 620 and the adjustment member 606, such extension is not necessary and is shown merely to facilitate the description of the embodiment illustrated in FIG. 6.

In some alternative embodiments, an outdoor-mountable electronic apparatus 302 with a housing 305 configured for secure electrical connector mounting to a fixture 350 may include a connector assembly having a connector 310 with a plurality of protruding conductors 315 arranged and configured in a substantially circular pattern, and a twistable or rotatable support sleeve 106 around a support housing 103-105. Once the connector assembly is coupled to a mating structure 352 of the fixture 350, the support sleeve 106, which may be in a threaded relationship with the support housing 103-105, may collapse the support housing 103-105 as the support sleeve 106 twists or turns around the support housing 103-105 to compress the support housing 103-105 against a collar 108 of the mating structure 352 to provide a secure connection between the electronic apparatus 302 and the fixture 350.

In some other alternative embodiments, the connector assembly may include an NEMA connector 310 that complies with the ANSI C136 roadway lighting series of standards. In some embodiments, the fixture 350 may be a streetlight. In some embodiments, the connector assembly may be an NEMA connector, and the fixture 350 may be a streetlight having a luminaire NEMA connector for mating with the NEMA connector of the outdoor-mountable electronic apparatus 302.

In some other embodiments, the mating structure of the fixture 350 may be a collar 108 of a luminaire NEMA connector 352, and the support sleeve 106 may twist or turn around the support housing 103-105 to compress the support housing 103-105 against the collar 108 of the luminaire NEMA connector 352 to provide a secure connection between the electronic apparatus 302 and the fixture 350. In some such embodiments, the twistable or rotatable support sleeve 106 around the support housing may operate in a manner similar to the operation of a chuck 200 of a drill.

In some embodiments, the outdoor-mountable electronic apparatus 302 may be one of a streetlight-mountable sensor, a streetlight-mountable wireless access point, or a streetlight-mountable small cell access node or device.

In some other alternative embodiments, a streetlight-mountable electronic apparatus 302 configured for secure electrical connector mounting to a streetlight luminaire 350 may include a NEMA connector assembly configured to mate with a NEMA connector 352 of the streetlight luminaire 350, and a twistable or rotatable support sleeve 106 configured around a support housing 103-105. In such an embodiment, once the NEMA connector assembly is coupled to the luminaire NEMA connector 352, the support sleeve 106 may collapse the support housing 103-105 as the support sleeve 106 twists or turns around the support housing 103-105 to compress the support housing 103-105 against the luminaire's NEMA connector 352 to provide a secure connection between the streetlight-mountable electronic apparatus 302 and the streetlight luminaire 350. In some alternative embodiments, the support sleeve 106 may be in a threaded relationship with the support housing 103-105.

In some other embodiments, the support sleeve 106 may twist or turn around the support housing 103-105 to compress the support housing 103-105 against a collar 108 of the luminaire's NEMA connector 352 to provide a secure connection between the electronic apparatus 302 and the streetlight luminaire 350. In some such embodiments, the twistable or rotatable support sleeve 106 may operate in a manner similar to the operation of a chuck 200 of a drill.

In some other alternative embodiments, an outdoor-mountable electronic apparatus connector assembly configured for secure mounting to a fixture 350 may include a plurality of protruding conductors 315 arranged in a substantially circular pattern and a twistable or rotatable support sleeve 106 around a support housing 103-105 configured and constructed in a threaded relationship with the support housing 103-105 to collapse the support housing 103-105 as the support sleeve 106 twists or turns around the support housing 103-105 to compress the support housing 103-105 against a mating structure 352 of the fixture 350 to provide a secure connection between the electronic apparatus connector 310 and the fixture 350. In some such embodiments, the outdoor-mountable electronic apparatus connector assembly forms a part of one of a streetlight-mountable sensor, a streetlight-mountable wireless access point, or a streetlight-mountable small cell access node or device. In some other embodiments, the connector assembly may include a NEMA connector 310, and the fixture 350 may be a streetlight having a luminaire NEMA connector 352 for mating with the NEMA connector 310. In some further embodiments, the twistable or rotatable support sleeve 106 may operate in a manner similar to the operation of a chuck of a drill.

In some further embodiments, the mating structure of the fixture 350 may be a collar 108 of a luminaire NEMA connector 352, and the support sleeve 106 may twist or turn around the support housing 103-105 to compress the support housing 103-105 against the collar 108 of the luminaire NEMA connector 352 to provide a secure connection between the electronic apparatus connector assembly and the fixture 350. In some such embodiments, the support sleeve 106 may be in a threaded relationship with the support housing.

The electronic apparatus 302, 501, 601 may be part of a system or network of streetlight poles, streetlight fixtures, streetlight sources, or the like in a system level deployment controlled by a municipality or other government agency. In other cases, the system may be controlled by a private entity (e.g., private property owner, third-party service contractor, or the like). In still other cases, a plurality of entities may share control of the system of streetlight poles, streetlight fixtures, streetlight sources, or the like.

In other embodiments, each electronic apparatus 302, 501, 601 may be equipped with communication capabilities, which allows for the monitoring or remote control of a light source of the streetlight fixture 350 or of another utility device. Accordingly, each light source in each streetlight fixture or in a broader context each device in any fixture may be remotely monitored and controlled independently or in combination. In the case of a streetlight fixture 350, each streetlight fixture may be monitored and/or controlled as an independent light source or in combination with other light sources where the electronic apparatus 302, 501, 601 may serve to provide the wireless (or wired) communication of light control signals and any other information (e.g., packetized data) between a remote monitoring and management system and the streetlight fixture 350.

As one non-limiting, non-exhaustive example, each electronic apparatus 302, 501, 601 may operate as a small cell-networking device to provide wireless cellular-based network communication services.

The electronic apparatus 302, 501, 601 is not limited to being mountable or attachable to a streetlight, but may be mountable or attachable to any number of objects, including, but not limited to, a light pole, an LED board, a bracket, a street sign, a highway sign, a bus stop shelter, an ATM, a phone booth, a building, an HVAC unit, a mailbox, a billboard, a light, a parking sign, a stop light, a speed limit sign, a solar cell, a crosswalk sign, a tunnel, a utility box, a water tower, a crane, a radio antenna tower, a store, an awning, a roof, or a parking pay station.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent.

Throughout this disclosure and the appended claims, the terms “include,” “have,” “contain,” and “comprise,” as well as derivatives thereof and in all of their syntactic contexts, are to be construed without limitation in an open, inclusive sense (e.g., “including, but not limited to”). The term “or,” is inclusive, meaning “and/or.” The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, features, structures, or characteristics of disclosed embodiments may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictate inclusivity or exclusivity, as the case may be. In addition, the composition of “and” and “or” when recited herein as “and/or” is intended to encompass an embodiment that includes all of the associated elements or operations and one or more other alternative embodiments that include fewer than all of the associated elements or operations.

As the context may require in this disclosure, the singular shall mean the plural and vice versa. Also, the masculine shall mean the feminine and vice versa.

The various embodiments described in this disclosure can be combined to provide further embodiments. Additionally, the disclosed embodiments can be modified, if necessary, to employ concepts of publicly disclosed devices, systems, and processes to provide further embodiments.

What is claimed is:

1. A retention apparatus for an electrical connector, the retention apparatus comprising:
a plurality of spatially adjustable retention members arranged about a perimeter of the electrical connector; and
an adjustment member surrounding the retention members and operable to selectively move the retention members toward the electrical connector when retention of the electrical connector is desired.

2. The retention apparatus of claim 1, further comprising:
a body member that retains the retention members in a predetermined arrangement relative to one another during movement of the retention members by the adjustment member.

3. The retention apparatus of claim 1, wherein the adjustment member is rotatable and operable to move the retention members toward the electrical connector when the adjustment member is rotated in a first direction.

4. The retention apparatus of claim 3, wherein the adjustment member is further operable to move the retention members away from the electrical connector when the adjustment member is rotated in a second direction that is opposite to the first direction.

5. The retention apparatus of claim 1, wherein the adjustment member is further operable to selectively move the retention members away from the electrical connector when retention of the electrical connector is not desired.

6. The retention apparatus of claim 1, wherein the electrical connector is configured to mate with a mating electrical connector located atop a streetlight luminaire and wherein the retention members are sized and shaped to engage with a collar of the mating electrical connector after the electrical connector has been mated with the mating electrical connector.

7. The retention apparatus of claim 6, wherein the electrical connector is a multi-pronged connector, and the mating electrical connector is a corresponding mating socket.

8. An electronic apparatus comprising:
a housing;
an electrical connector; and
a retention apparatus for the electrical connector, the retention apparatus including:
a plurality of spatially adjustable retention members arranged about a perimeter of the electrical connector; and
an adjustment member surrounding the retention members and operable to selectively move the retention members toward the electrical connector when retention of the electrical connector is desired.

9. The electronic apparatus of claim 8, wherein the adjustment member is further operable to selectively move the retention members away from the electrical connector when retention of the electrical connector is not desired.

10. The electronic apparatus of claim 8, wherein the retention apparatus further includes:
a body member that retains the retention members in a predetermined arrangement relative to one another during movement of the retention members by the adjustment member.

11. The electronic apparatus of claim 8, wherein the adjustment member is rotatable and operable to move the retention members toward the electrical connector when the adjustment member is rotated in a first direction.

12. The electronic apparatus of claim 11, wherein the adjustment member is further operable to move the retention members away from the electrical connector when the adjustment member is rotated in a second direction that is opposite to the first direction.

13. The electronic apparatus of claim 8, wherein the electrical connector is configured to mate with a mating electrical connector located atop a streetlight luminaire and wherein the retention members are sized and shaped to engage with a collar of the mating electrical connector after the electrical connector has been mated with the mating electrical connector.

14. The electronic apparatus of claim 13, wherein the electrical connector is a multi-pronged connector, and the mating electrical connector is a corresponding mating socket.

15. The electronic apparatus of claim 8, wherein the retention apparatus is integrated with the housing.

16. A streetlight-mountable electronic apparatus comprising:
a housing;
an electrical connector interconnectable with a mating electrical connector located atop a luminaire of a streetlight; and
a retention apparatus for the electrical connector, the retention apparatus including:
a plurality of spatially adjustable retention members arranged about a perimeter of the electrical connector so as to be outside a diameter of a collar of the mating electrical connector; and
a rotatable adjustment member surrounding the retention members and operable to move the retention members toward the electrical connector to permit engagement with the collar of the mating electrical connector when the adjustment member is rotated in a first direction.

17. The streetlight-mountable electronic apparatus of claim 16, wherein the retention apparatus further includes:
a body member that retains the retention members in a predetermined arrangement relative to one another during movement of the retention members by the adjustment member.

18. The streetlight-mountable electronic apparatus of claim 16, wherein the adjustment member is further operable to move the retention members away from the electrical connector to permit disengagement with the collar of the mating electrical connector when the adjustment member is rotated in a second direction that is opposite the first direction.

19. The streetlight-mountable electronic apparatus of claim 16, wherein the electrical connector is a multi-pronged connector, and the mating electrical connector is a corresponding mating socket.

20. The streetlight-mountable electronic apparatus of claim 16, wherein the retention apparatus is integrated with the housing.
